(19) United States
(12) Patent Application Publication
(10) Pub. No.: US 2008/0270020 A1
(43) Pub. Date: Oct. 30, 2008

(54) Method, Arrangement and Monitoring Device for Navigation of Aircraft and Ground Vehicles Using Satellite-Assisted Positioning

(75) Inventor: Gerhard Raab, Buttelborn (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, Munich (DE)

(21) Appl. No.: 12/092,493

(22) PCT Filed: Oct. 5, 2006
(86) PCT No.: PCT/EP06/67108

§ 371 Date: May 2, 2008

(30) Foreign Application Priority Data
Nov. 9, 2005 (DE) 10 2005 053 499.6

(51) Int. Cl. G08G 5/06

(52) U.S. Cl. 701/201

(57) ABSTRACT

On reaching an approach area to a destination airport, the aircraft is provided with up-to-date topographical information and route information in addition to a destination position on the ground. Wireless communication technologies, such as GSM, GPRS, UMTS, WLan, WiMax, and the like are used to transmit this information. Advantageously, the transmitted information can be displayed on a commercially available navigation system on board the aircraft and can be used for navigation on the ground.

The invention relates to the satellite-assisted navigation of ground vehicles and of landed aircraft within the area of an airport.

It is not just the safe and effective movement of aircraft during flight that has a role to play in the smooth handling of air traffic. Their movements on the ground are also of great importance in this regard. Before taking off the aircraft must be moved from its parked position to its takeoff position. After landing it must be moved from its landing position to its parked position which is frequently at a ground handling position (known as a gate).

After an aircraft has landed the task of the pilot is to move the aircraft quickly and safely to the parking position notified to him by a control facility (e.g. control center in the airport control tower). In such cases the landing position and the parking position can be several kilometers away from each other.

Pilots in such cases frequently have the problem after landing of not being immediately able to readily find their bearings. The reasons for this can for example be the size of the airport, the sudden change of the reference environment from the extensive airspace to the comparatively narrow ground area of an airport or difficulties with visibility. In many cases, especially if flying into the airport for the first time, pilots have no information about where their intended parking position is located. In addition the radio frequencies of the ground control which could give them such information are frequently overloaded. The airport signs, on the taxiways for example, are also not optimally standardized as yet.

The problem occurs especially if—for reasons of weather or safety for example—aircraft have to fly into alternate airports. Those piloting the aircraft are in many cases not familiar with the layout on the ground at these airports since they have rarely or never flown into them.

Basically the controller of the ground control directs the pilot to the position provided using voice radio communication. In such cases it should be taken into account that the radio frequencies on the ground and in the air are overloaded to such an extent that there are European programs which are aiming to reduce the radio traffic significantly.

In many cases the speech tempo of the ground controllers is so high or their comprehensibility over radio so low that the highest levels of concentration are required from pilots to understand the instructions of the ground controllers and to be able to follow them. Another factor which makes matters difficult is that the voice traffic is always general and thus heard by all—and thus also by those not affected by a particular instruction given over the radio. This further increases the demands made on the concentration of the airline pilot for reaching the stand position, since they must constantly pay attention to whether they are being given an instruction at a particular moment.

Delays arising in the movements of the aircraft on takeoff runways, landing runways and taxiways and at the parking positions have a negative effect—simply in their totality—on the entire air and ground traffic of an airport. In many cases they are responsible for contributing to the delays that arise.

The best known solution is to carry on board the aircraft maps with diagrams of the geographical details of the airport. The cockpit crew carries with them such mapping material by default for the actual destination airports, diversion airports and airports along the flight path which can be flown into in emergencies.

The use of such maps for the movement of the aircraft on the ground is however not mandatory. Their use also requires a certain amount of time in order to orient oneself. This is because the on-board compass first has to be used to orient the map to the North. Then the map view has to be reconciled with what the pilot can see from the aircraft, e.g. landmark buildings or other features.

Another solution is the radio voice traffic with the tower discussed above with its problems already addressed.

The so-called “Visual Guidance System” represents a further solution, in which light sources (known as beacons) are let into a center line of the taxiway to show pilots their route to the parking position by means of trail of green lights. This technology is very expensive to implement and therefore is only rarely encountered (e.g. at London-Heathrow and Hong Kong).

A further method is known from application US 2004/0225432 A1 which is based for navigation at an airport and in the surrounding airspace on global positioning system (GPS) navigation. In this case a reference antenna is used to create a position signal for reference, by means of which the remaining GPS signals can be corrected for the purposes of greater accuracy (known as differential GPS).

The object of the invention is to organize the ground navigation of aircraft and ground vehicles more safely and more effectively at airports. This object is achieved, using the descriptive part of claims 1, 23 and 24 as its basis, by the characterizing part of these claims.

The advantages of the invention are:
More effective and safer organization of the aircraft movements on the ground,
The communication of up-to-the-minute topographical map information and destination position information to the aircraft for ground navigation at the airport,
Relieving the pilot and the ground controllers of the burden of ground navigation,
The communication of particular traffic guidance information from a control facility to the aircraft, such as especially stop instructions, speed restrictions, information about hazards,
The integrated ability to present all the ground activities of aircraft and ground vehicles in a control facility, e.g. the tower or a control center in its entirety or in functional or topographical sections,
The drastic reduction of radio voice traffic,
Expensive ground installations, such as antennas or sensors for example, are not needed when GSM, GPRS or UMTS are used, and only to an manageable extent with WLAN or WiMAX, which also makes their use possible at regional airports,
Databases for geographical airport maps on board the aircraft are not necessary,
By evaluating the collected information turnaround times are able to be used for accounting or controlling purposes,
The whereabouts and current position of ground facilities can be established via a monitor in a control center,
Low-cost, commercially-available terminals can be employed, e.g. PDA with GPRS and GPS.

The invention is explained below on the basis of exemplary embodiments and with reference to the enclosed drawings. The figures show:

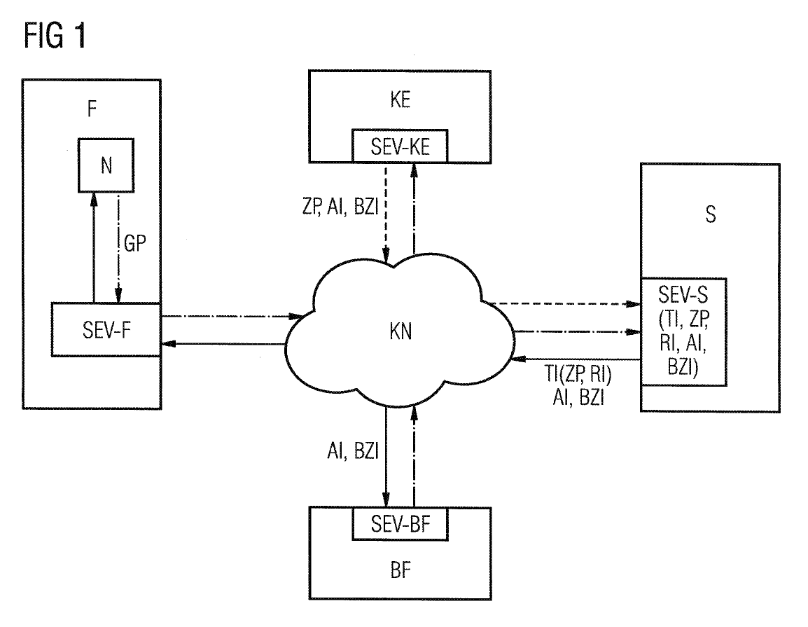

FIG. 1, 2: the schematic execution sequence of the method,

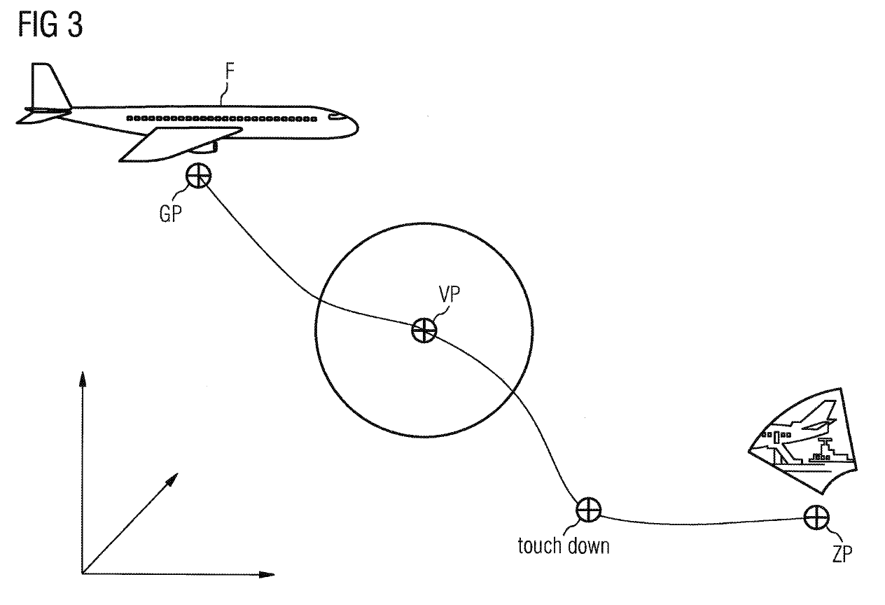

FIG. 3: a schematic diagram of the flight path of an aircraft before landing and its taxi path after landing,

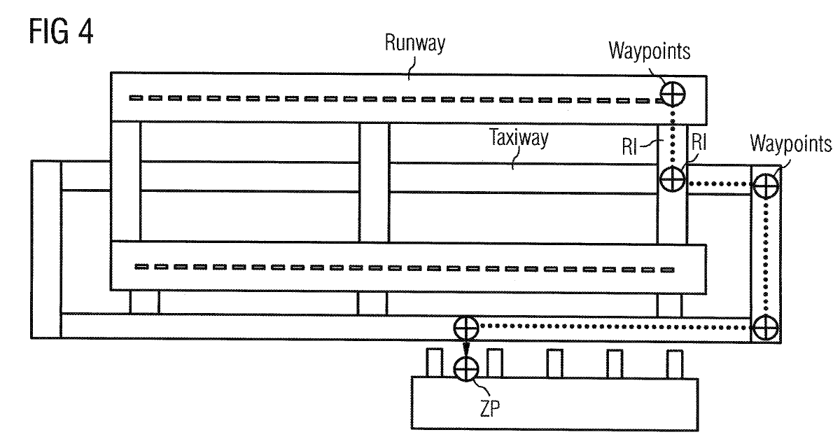

FIG. 4: a schematic diagram of the taxi path viewed from above.

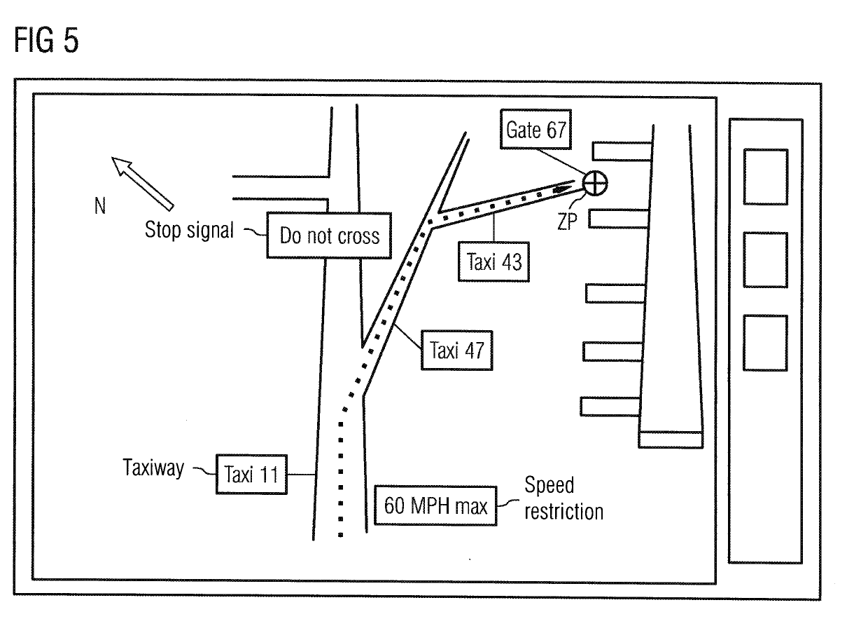

FIG. 5: a schematic diagram of the display device of a navigation system.

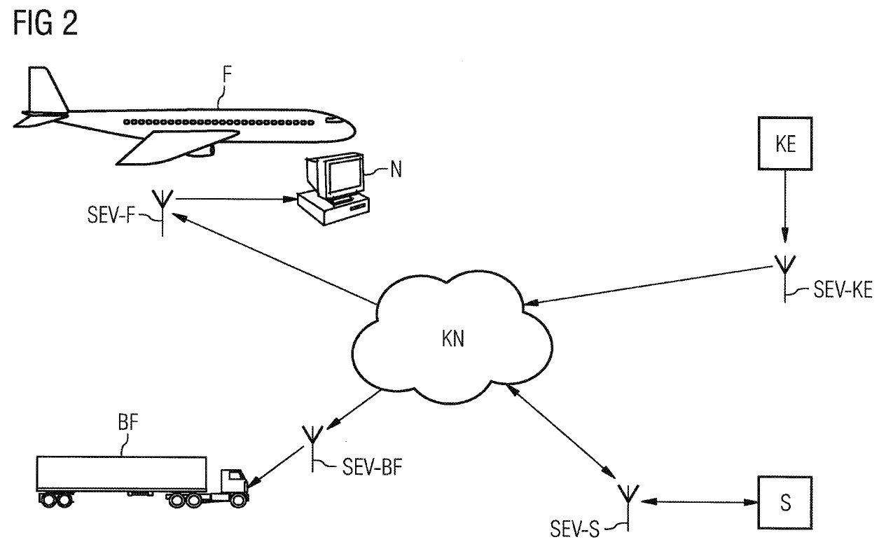

A first exemplary embodiment relates to an aircraft F landing at an airport (FIG. 3). The aircraft F has a navigation system N (FIG. 2) on board which determines its geographical position at cyclic intervals using the global positioning system (GPS). The navigation system N is connected via a transmit and receive device SEVF to a communication network KN (FIG. 2).

Also connected to this communication network KN are a control facility KE and a memory S, which likewise have transmit and receive systems SEV-KE, SEV-S (FIG. 2).

To guarantee safe and orderly handling of the aircraft F on the ground, the control facility KE, before or during the approach of the aircraft F, creates a final destination position ZP on the ground allocated to the aircraft F and transfers it to a memory S (FIG. 1).

In addition digitized topographical information TI, updated at regular intervals and/or as required, pertaining to the circumstances on the ground at the airport such as taxiways, gates, building sites, hazards and obstructions, is stored in the memory S (FIG. 1).

Also stored in this memory S is route information RI about the optimum path of the aircraft F from its landing position to its destination position ZP on the ground. In such cases obstacles to the movement of traffic occurring over the short term and the other traffic in the air and on the ground can be taken into account when calculating this path (FIG. 1).

Well before a predetermined geographical area is reached a communication link is established in the approach via the communication network between the aircraft F and the memory S. Once the aircraft F reaches a predefined geographical position VP in this predetermined area during its approach (FIG. 3), this fact is notified to the memory S and detected in the latter. In such cases use is advantageously made especially of an existing mobile communication technology and its protocols—such as GSM, GPRS, UMTS or WiMAX.

After memory S has detected that the aircraft F is located in the predetermined geographical area, the topographical information TI containing at least the destination position ZP and the route information RI, is transmitted from memory S to the navigation system N (FIG. 1, 2).

This information TI, ZP and RI can then be displayed in the aircraft F in the form of an electronic map display on a display device (FIG. 5).

Based on the presentation of the route information RI, the pilot can move his aircraft F directly to its destination position ZP, without having to first find his bearings at the airport. Expensive radio voice contact with the control facility KE to do this is also no longer required for ground navigation. The pilot can simply follow the presentation shown on the display, which if necessary can even show further traffic information, especially instructions to stop or taxiing speed restrictions, hazards (FIG. 5).

In such cases a new communication link can be established each time to transfer updated topographical information TI once again to the navigation system N. This can be helpful if for example an unforeseen blockage of a taxiway has occurred because of an incident. In such a case the aircraft can be allocated a new route using updated route information RI. In precisely the same way the aircraft F can also be allocated a different destination position ZP.

A further exemplary embodiment relates to the coordinated use of ground vehicles BF, here for example the refueling of the aircraft F by a fuel tanker.

After an aircraft F has landed and reached its destination position ZP ground handling is undertaken for the aircraft. This includes refueling among other operations, to enable the aircraft to fly on to its next destination.

To this end the control facility KE decides which fuel tanker will handle this task. Previously this information has primarily been communicated to the ground vehicle BF by means of a written order and by voice over the radio.

According to the invention navigation information AI “refuel” together with ground destination information BZI—namely the location of the aircraft F to be refueled—is now created in the control facility KE and transmitted over a wireless communication link to the memory S and from there to the fuel tanker, which also has a transmit and receive system SEV-BF.

It is useful—as in the previous exemplary embodiment—for no particularly complex technology to be required for transmission, but to be able to make use of known and proven technology and its protocols—such as GSM, GPRS, UMTS, WLAN or WiMAX for example.

The fuel tanker has a GPS system for establishing its position. In addition to pure positioning, a standard function of GPS systems is also to provide speed information based on measurement of time and determination of the distance covered.

This position, orientation and speed information is transmitted via the communication network KN to the control facility KE, which thus has precise information pertaining to the correspondingly equipped aircraft and ground vehicles. For better understanding of the information of the large amounts of different information and how it is interpreted, this can advantageously be displayed on a display device.

If for example the control facility KE has asked a specific ground vehicle to refuel the aircraft F at a specific gate, the corresponding navigation information AI and the ground destination information BZI is transferred to the ground vehicle.

Sometimes delays arise during the further course of ground handling.

Previously the control facility has had to establish a voice connection in order to determine the reason for the delay (known as escalation). Now a simple glance at the display screen is sufficient. This immediately shows that the fuel tanker has been waiting for a short time (speed 0) and the aircraft is only just swinging round into its parking position. Since under normal circumstances the aircraft can only be fueled once all passengers have disembarked, it is worthwhile immediately assigning the fuel tanker another urgent task in order to eliminate waiting time and make better use of resources.

On the other hand a monitoring function of the ground handling team does not have to undertake any “escalation” for the previously overdue fueling if it is evident at the control facility KE that the refueling vehicle is currently en route to the appropriate aircraft. This discernibly reduces the coordination outlay, which leads to labor savings.

The invention is not on restricted to the exemplary embodiment but can also be used to control other aircraft and ground vehicles, such as baggage handling or catering vehicles. These vehicles are to be configured according to the invention.

1-21. (canceled)

22: A method of navigating an aircraft on the ground, the method which comprises:
continuously determining a current position of the aircraft in the aircraft;
storing a destination position on the ground provided for the aircraft in a memory by a control device;
before or upon reaching a predefined geographical position, establishing a communication link via a communication network between a navigation system in the aircraft and the memory; and
when the predefined geographical position is reached by the aircraft, communicating topographical information to the navigation system from the memory, the topographical information containing at least one of the following:
the destination position provided for the aircraft; and/or
route information about a route from the current position to the destination position.

23: The method according to claim 22, wherein the route information includes waypoints to be passed by the aircraft on the route from the current position to the destination position.

24: The method according to claim 22, which comprises updating at least one item of the topographical information in the memory S regularly and/or on-demand.

25: The method according to claim 22, wherein, if topographical information changes, creating corresponding information and transmitting same to the aircraft by way of an update.

26: The method according to claim 22, which comprises displaying at least part of the topographical information on a display device of the aircraft.

27: The method according to claim 26, which comprises displaying the topographical information in the aircraft with a navigation system display.

28: The method according to claim 26, which comprises configuring the topographical information to enable a display of at least the route information about a path to be followed by the aircraft from the current position to the destination position on a display device in the aircraft and/or to enable a display of at least the current position of the aircraft on a display device of the control device.

29: The method according to claim 26, which comprises enabling an electronic presentation of the topographical information on the display device of the aircraft to be oriented to specific criteria selected by a user.

30: The method according to claim 29, wherein the user-selectable specific criteria include a compass point North and a longitudinal axis of the aircraft pointing forward.

31: The method according to claim 26, wherein, depending on additional criteria, communicating different alternate topographical information, from the control device and from the memory to the navigation system.

32: The method according to claim 31, which comprises displaying the alternate information upon selection by a user.

33: The method according to claim 31, wherein the additional criteria include traffic and weather, and the alternate topographical information includes alternate route information.

34: The method according to claim 22, wherein the communication network is a wireless system between the navigation system and the memory.

35: The method according to claim 22, wherein the communication network is selected from a network system based on GSM, GPRS, UMTS, WLAN, WiMAX, and/or DECT.

36: The method according to claim 22, which comprises further processing the topographical information and/or route information in the aircraft with at least one of the following:
optimized by entries made by a pilot; and/or
taking into account information from a further system used for optimizing ground traffic;
taking into account information from an arrival management system; and/or
taking into account information of a light signal-supported aircraft taxiing guidance system on the ground and/or stop signals.

37: The method according to claim 22, which comprises selectively communicating control information relating to a navigation of the aircraft, from the control device to the navigation system.

38: The method according to claim 37, which comprises transmitting instructions for stopping the aircraft at specific topographical positions from the control device to the navigation system of the aircraft.

39: The method according to claim 22, which comprises generating in the control device, depending on the destination position of at least one aircraft, ground destination information and/or navigation information for at least one ground vehicle, and transmitting same to at least one respective ground vehicle.

40: The method according to claim 39, which comprises determining a position of the ground vehicle in the ground vehicle at regular intervals and/or at the request of the control device and transmitting the position over the communication network to the control device.

41: The method according to claim 39, which comprises editing in the control device at least one of the current position, the navigation information, the destination position of the ground vehicle and/or of the aircraft to enable a display thereof on at least one display device.

42: The method according to claim 39, wherein the control device incorporates a zoom function for selectively reducing or enlarging the presentation of the current position and/or the navigation information and/or the destination position of at least of the ground vehicle or the aircraft on at least one display device.

43: The method according to claim 39, wherein the control device is configured to selectively subdivide the presentation of the current position and/or the action information and/or the destination position of at least of the ground vehicle or the aircraft into parts or sections.

44: The method according to claim 39, which comprises presenting in the control device, at least the ground vehicle or the aircraft on at least one display device by way of a unique identifier.

45: The method according to claim 44, wherein the unique identifier is selected from the group consisting of a call sign of the aircraft, a flight number of the aircraft, or an identifier of the aircraft.

46: The method according to claim 39, wherein control device is configured to show a display of at least the ground vehicle or the aircraft on at least one display screen, of at least one of the following:
a distance covered on the ground by the aircraft;
a distance on the ground still to be covered by the aircraft;
the destination position;
a current speed of the aircraft;
a movement status, including a status of moving or a status of stationary; and
an alignment of the aircraft along a longitudinal axis.

47: The method according to claim 39, which comprises utilizing at least two satellite-based navigation systems and displaying at least one of a direction of travel and a direction in which the aircraft is standing in the control device.

48: The method according to claim 47, wherein the satellite-based navigation systems are mounted respectively at a front and a rear of the aircraft.

49: An arrangement for navigating an aircraft on the ground by way of satellite-based global positioning, configured to execute the method steps according to claim 22.

50: A control device for navigating an aircraft on the ground using satellite-based global positioning, configured to execute the method steps according to claim 22.
